(19) United States
(12) Patent Application Publication
(10) Pub. No.: US 2004/0125608 A1
(43) Pub. Date: Jul. 1, 2004

(54) Irradiating direction control apparatus of headlamp for vehicle

(76) Inventor: Makoto Izawa, Shizuoka (JP)

Correspondence Address: FISH & RICHARDSON P.C., 45 ROCKEFELLER PLAZA, SUITE 2800, NEW YORK, NY, 10111, US

(21) Appl. No.: 10/716,245

(22) Filed: Nov. 18, 2003

(30) Foreign Application Priority Data
Nov. 20, 2002 (JP) P. 2002-336259

(51) Int. Cl. B60Q 1/00

(52) U.S. Cl. 362/464; 362/465

(57) ABSTRACT

An irradiating direction control apparatus 1 of a headlamp for a vehicle includes vehicle posture detecting means 2 for detecting a change in the posture of the vehicle, irradiation control means 3 for calculating a pitch angle indicative of a vertical inclined posture in a direction of advance of the vehicle based on detected information thereof and computing a control amount for correcting an optical axis of irradiation related to the headlamp 5, and setting a ground angle of the optical axis of the irradiation in a deceleration (or an acceleration) of the vehicle to be smaller (or greater) than a ground reference angle of the optical axis of the irradiation during stop or constant speed running of the vehicle, thereby carrying out a correcting calculation for maintaining a forward visible distance of the vehicle to be constant, and driving means 4 for changing a direction of the optical axis of the irradiation of the headlamp 5 upon receipt of a control command sent from the irradiation control means 3. The direction of the optical axis of the irradiation is controlled in such a manner that the forward visible distance is maintained to be almost constant depending on the pitch angle calculated based on vehicle posture detection information.

### BACKGROUND OF THE INVENTION

1. Field of the Invention

The present invention relates to a technique for maintaining a sufficient visible distance also in a state in which the front part of a vehicle sinks during a deceleration to guarantee a distant visibility and for preventing the optical axis of irradiation from being turned excessively upward during an acceleration in an irradiating direction control apparatus of a headlamp for the vehicle.

2. Description of the Related Art

There has been known an apparatus for correcting and controlling the irradiating direction of a head lamp for a vehicle depending on a change in the posture of the vehicle. For example, the pitch angle of the vehicle is calculated from information detected by vehicle height detecting means provided in the axle portions of the front and rear parts of the vehicle to drive the reflecting mirror of a lighting unit in order to cancel the change, thereby carrying out correction and control to maintain the ground angle of the optical axis of irradiation to be constant in an apparatus for automatically regulating an irradiating direction to hold the irradiation state of a headlamp to be set in a predetermined state also in the case in which a vertical inclination in the forward direction of a vehicle body is changed, which is known for so-called an auto-leveling apparatus such as disclosed in FIGS. 1 and 7 of JP-A-10-226271.

In a conventional irradiating direction control apparatus, an optical axis is corrected and controlled in such a manner that the ground angle of the optical axis of irradiation of a headlamp becomes constant depending on a change in the posture of a vehicle. Therefore, there is a possibility such that the visible distance of the driver of the vehicle might be reduced depending on the running state of the vehicle.

For example, in the case in which the vehicle suddenly decelerates immediately before an entrance to a curved road so that the front portion of the vehicle sinks due to a nosedive thereof, the ground clearance of the headlamp additionally provided in the front part of the vehicle is reduced even if the ground angle of the optical axis of the irradiation of the headlamp is set to be constant by the correction of the optical axis. Consequently, the forward visible distance of the vehicle is reduced.

In a typical explanatory view of FIG. 4, a straight line “a” shown in a solid line indicates a reference line of a change in a vehicle height and a broken line “b” conceptually represents a state in which the front part of the vehicle sinks downward due to a nosedive.

In the case in which the ground angle of the optical axis of the irradiation is represented by “α”, the height of the headlamp based on a ground is represented by “Hhl” and a visible distance is represented by “L”, “tan()” is set to be a tangential function and they have a relationship of “Hhl/L=tan(α)” or “L=Hhl/tan(α)”. If a value of α is constant, accordingly, a change in Hhl directly appears as a change in L. “L′ < L” is obtained as shown in the drawing, wherein the visible distance in the nosedive is represented by “L′”.

A light excessively arrives distantly in such control as to maintain the ground angle of the optical axis of the irradiation to be constant when the front part of the vehicle rises due to a noseup in the acceleration of the vehicle. According to circumstances, there is a possibility that a glare might be generated over a car running in an opposite direction.

### SUMMARY OF THE INVENTION

Therefore, it is an object of the invention to maintain a forward visible distance in a deceleration and to prevent a glare from being generated over a car running in an opposite direction at time of an acceleration in an irradiating direction control apparatus of a headlamp for a vehicle.

The invention has the following structure in an apparatus for controlling the irradiating direction of a headlamp for a vehicle depending on a change in the posture of the vehicle.

Vehicle posture detecting means for detecting the change in the posture of the vehicle.

Irradiation control means for calculating a pitch angle indicative of a vertical inclined posture in a direction of advance of the vehicle based on information detected by the vehicle posture detecting means and computing a control amount for correcting an optical axis of irradiation related to the headlamp for the vehicle, and setting a ground angle of the optical axis of the irradiation in a deceleration of the vehicle to be smaller than a ground reference angle of the optical axis of the irradiation during stop or constant speed running of the vehicle, and furthermore, setting the ground angle of the optical axis of the irradiation in an acceleration of the vehicle to be greater than the ground reference angle of the optical axis of the irradiation during the stop or constant speed running of the vehicle, thereby carrying out a correcting calculation for maintaining a forward visible distance of the vehicle to be constant.

Driving means for changing a direction of the optical axis of the irradiation of the headlamp for the vehicle upon receipt of a control command sent from the irradiation control means.

According to the invention, therefore, the direction of the optical axis of the irradiation is controlled in such a manner that the forward visible distance is maintained to be almost constant depending on the pitch angle calculated based on the information detected by the vehicle posture detecting means. For example, in the deceleration of the vehicle, the irradiating direction is defined to have a smaller ground angle than the ground reference angle of the optical axis of the irradiation. Consequently, it is possible to maintain the forward visible distance which is necessary for the running of the vehicle. This depends on the fact that α is decreased so that a visible distance L is maintained to be constant even if Hhl is reduced due to the sink of the front part of the vehicle as is apparent from the above equation “L=Hhl/tan(α)”. Moreover, the irradiating direction is defined to have a greater ground angle than the ground reference angle of the optical axis of the irradiation in the acceleration of the vehicle. Therefore, it is possible to prevent a glare from being generated over the driver of a car running in an opposite direction or a road user.

### BRIEF DESCRIPTION OF THE DRAWINGS

FIG. 1 is a diagram showing an example of the basic structure of an irradiating direction control apparatus according to the invention,

FIG. 2 is an explanatory view showing the posture of a vehicle and an irradiating state during the stop or constant speed running of the vehicle,

FIG. 3 is an explanatory view showing the posture of the vehicle and the irradiating state in the deceleration of the vehicle, and

FIG. 4 is a schematic view for explaining a conventional problem.

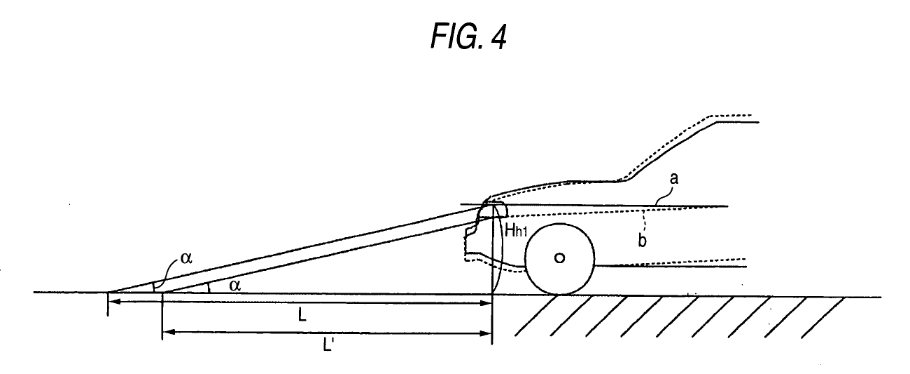

### DESCRIPTION OF THE PREFERRED EMBODIMENTS

The invention has an object to prevent a forward visible distance from being reduced due to a nosedive in the deceleration of a vehicle in an application to a leveling apparatus (a so-called auto-leveling apparatus) for controlling an irradiating direction following a change in the posture of the vehicle.

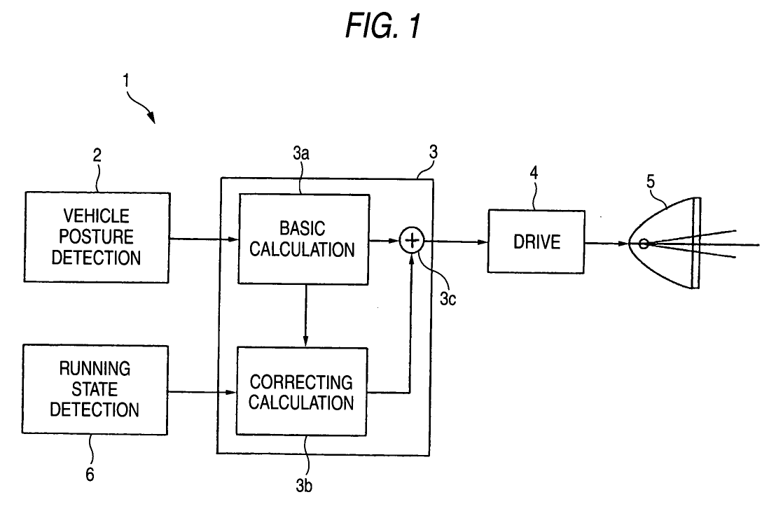

FIG. 1 shows the basic structure of an irradiating direction control apparatus according to the invention.

An irradiating direction control apparatus 1 comprises vehicle posture detecting means 2, irradiation control means 3 and driving means 4, and controls the direction of the optical axis of irradiation related to a headlamp 5 for the vehicle. Examples of the headlamp include a headlamp, a fog lamp and a cornering lamp in a lighting unit for an automobile.

The vehicle posture detecting means 2 is provided for detecting the posture of a vehicle in a stationary state and/or running (including an inclination in a vertical plane in the direction of advance of the vehicle), and serves to detect a vehicle height value in the axle portion of a wheel and the inclination of the posture of the vehicle in the direction of advance. For example, in the case in which vehicle height detecting means (a vehicle height sensor) is used, it is possible to employ a method of detecting a vehicle height displacement related to the axle portions of the front and rear wheels of the vehicle and a method of measuring a distance between the vehicle height detecting means and a road surface.

The information detected by the vehicle posture detecting means 2 is transmitted to the irradiation control means 3 to calculate a pitch angle indicative of a vertical inclined posture in the direction of advance of the vehicle and to compute a control amount for correcting the optical axis of irradiation related to the headlamp 5.

At time of the sudden deceleration of the vehicle, as described above, a ground clearance (hereinafter referred to as “Hhl”) of the headlamp is reduced with a nosedive. In control in which the ground angle of the optical axis of the irradiation of the headlamp is maintained to be constant, therefore, a forward visible distance is reduced.

Therefore, the irradiation control means 3 sets the ground angle of the optical axis of the irradiation in the deceleration of the vehicle (which will be hereinafter referred to as “β”) to be smaller than the ground reference angle of the optical axis of the irradiation (which will be hereinafter referred to as “α”) during the stop or constant speed running of the vehicle, thereby carrying out a correcting calculation for maintaining the forward visible distance of the vehicle to be constant (the details will be described below).

The irradiation control means 3 is constituted by using computing means such as a computer, and a calculation for calculating the pitch angle of the vehicle and a calculation for controlling the optical axis of the irradiation are carried out as a software processing. For easy understanding, FIG. 1 separately shows a basic calculation section 3a and a correcting calculation section 3b which are related to control in the direction of the optical axis of the irradiation.

The basic calculation section 3a calculates a vehicle pitch angle from the detected information about the posture of the vehicle which is obtained by the vehicle posture detecting means 2 and correspondingly computes a control amount for correcting the optical axis of the irradiation. In other words, the basic calculation section 3a computes a control amount for regulating the direction of the optical axis of the irradiation of the headlamp 5 to be slightly downward when a vehicle body is brought into a forward and upward state. To the contrary, the basic calculation section 3a computes a control amount for regulating the direction of the optical axis of the irradiation of the headlamp 5 to be slightly upward when the vehicle body is brought into a forward and downward state. In brief, the basic calculation section 3a plays a part in the calculation of a basic control amount for offsetting a change in the optical axis of the irradiation which is caused by a variation in the pitch angle.

Moreover, the correcting calculation section 3b carries out a correcting calculation for maintaining a forward visible distance to be almost constant based on a relationship of “β<α” during a nosedive in consideration of a variation in Hhl at time of the deceleration of the vehicle. In other words, the basic calculation section 3a serves to calculate a control amount in such a manner that the ground angle of the optical axis of the irradiation has a constant value α for a change in the pitch angle during the stop or running of the vehicle. Accordingly, the correcting calculation section 3b is provided to maintain a forward visible distance to be constant by changing β in consideration of a variation in the height of Hhl during an acceleration or a deceleration. A correction value calculated by the correcting calculation section 3b is transmitted to an adding section 3c and is added to or subtracted from a calculated value transmitted from the basic calculation section 3a, and is thereby reflected on the control amount related to the direction of the optical axis of the irradiation. In other words, the output signal of the adding section 3c is transmitted to the driving means 4 and is changed into a control command for correcting the optical axis of the irradiation of the headlamp 5.

The driving means 4 serves to change the direction of the optical axis of the irradiation of the headlamp 5 upon receipt of a signal sent from the irradiation control means 3, and tilts a whole lighting unit or drives an optical component such as a lens, a reflecting mirror or a shade. For example, various configurations in which the reflecting mirror is tilted on a vertical plane including an optical axis have been known as a structure in which the driving mechanism (or adjusting mechanism) of the optical axis of the irradiation is moved to carry out the leveling control of the headlamp 5 by using a motor and a driving circuit thereof.

Running state detecting means 6 is provided to detect the running state of a vehicle (a speed or an acceleration) and includes the following means, for example.

Vehicle speed or wheel speed detecting means (a speed sensor),

Acceleration detecting means (an acceleration sensor), and

Current position information acquiring means for vehicle (GPS (Global Positioning System) and a car navigation device utilizing a vehicle roadside communication).

In each means, information about the direction and magnitude of the acceleration of the vehicle is transmitted to the irradiation control means 3 so that the running state of the vehicle including a stop state is detected.

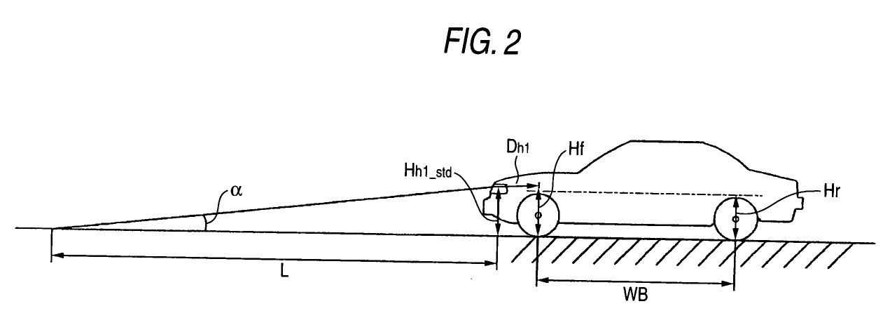

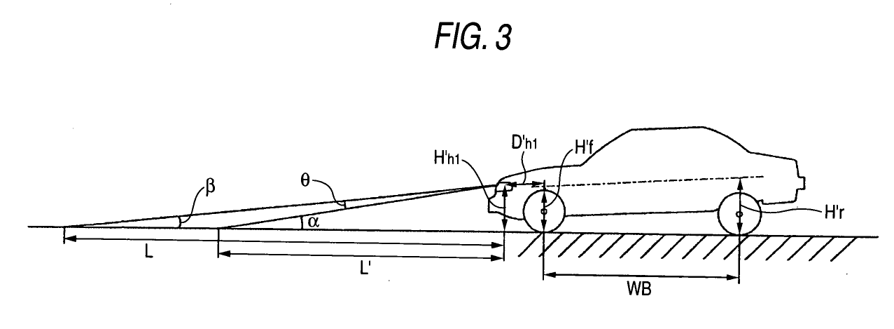

FIGS. 2 and 3 are schematic views for explaining the correction and control of the optical axis in the irradiation control means 3. FIG. 2 typically shows a state in which the vehicle stops or a state in which the vehicle runs at a constant speed (hereinafter referred to as a “reference state”), and FIG. 3 typically shows the deceleration state of the vehicle.

The meaning of symbols used in these drawings is as follows.

“L”= a forward visible distance at a ground reference angle α (a reference state) or a ground angle β(during the deceleration of a vehicle) of the optical axis of irradiation,

“L′”=a forward visible distance at a ground angle a (during the deceleration of the vehicle) of the optical axis of the irradiation,

“Hhl_std”=a reference value (a reference height) of a ground clearance Hhl of a headlamp in the reference state,

“H′hl”=a ground clearance of the headlamp in the deceleration of the vehicle,

“Hf”=a vehicle height of the axle portion of a front wheel in the reference state (a distance from a ground to a vehicle height detecting position),

“H′f”=a vehicle height of the axle portion of the front wheel in the deceleration of the vehicle (a distance from the ground to the vehicle height detecting position),

“Hr”=a vehicle height of the axle portion of a rear wheel in the reference state (a distance from the ground to the vehicle height detecting position),

“H′r”=a vehicle height of the axle portion of the rear wheel in the deceleration of the vehicle (a distance from the ground to the vehicle height detecting position),

“Dhl”=a distance between the vehicle height detecting position of the axle portion of the front wheel and (a light emission reference position in) the headlamp in the reference state,

“D′hl”=a distance between the vehicle height detecting position of the axle portion of the front wheel and (the light emission reference position in) the headlamp in the deceleration of the vehicle,

“WB”=a wheel base of the vehicle, and

“θ”=an optical axis correcting angle (=α−β).

α and β have been described above.

First of all, in the reference state shown in FIG. 2, a relationship of “Hhl_std/L =tan(α)” or “L=Hhl_std/tan(α)” is formed.

Moreover, a pitch angle is obtained from “φp=arctan ((Hf−Hr)/WB)” by using “tan(φp)=(Hf−Hr)/WB” or an inverse tangential function “arctan ( )”, wherein the pitch angle is represented by “φp”. Since an angle value in the reference state is small, the control amount related to the optical axis of the irradiation is comparatively small.

In the deceleration state shown in FIG. 3, the front part of the vehicle sinks due to a nosedive so that the rear part of the vehicle is brought into a floating state. At this time, the pitch angle is calculated from “(φp=arctan ((H′f-H′r)/WB)”.

Moreover, the following equation is obtained from geometric relationships of “α=β+θ” and “β=arctan (H′hl/L)” for angles αβand θ(In the drawing, the relationships between the angle values of α and β and lengths of L and L′ are shown exaggeratedly).

θ=α−β=α−arctan (H′hl/L)

In order to increase the visible distance from L′ to L by setting the ground angle of the optical axis of the irradiation to be β, accordingly, it is apparent that θ is preferably calculated by using the above equation to compute a control amount related to the optical axis of the irradiation based on an amount added to the pitch angle φp. More specifically, in the conventional control, there is performed control for maintaining the ground angle of the optical axis to be a constant reference angle α when the front part of a vehicle is brought down in a deceleration (corresponding to the case of θ=0 based on a α=β). As a result, a forward visible distance is reduced as shown in L′ (that is, “L′=H′hl/tan(α)<L”). On the other hand, in the invention, the angle β obtained as an inverse tangent of a ratio of Hhl (=H′hl) to L is subtracted from the ground reference angle a to calculate θ, and θ is added as a correction value to the value of the pitch angle so that a corrected amount is obtained. A control amount corresponding to the corrected amount is calculated and a change in an angle corresponding to θ is added to the optical axis so that the ground angle of the optical axis of the irradiation is set to be β. Thus, the forward visible distance is controlled to have a constant value (L).

In order to obtain β, it is necessary to calculate H′hl. A variation in the height of the headlamp in the nosedive is obtained from the Dhl and φp. Therefore, the variation is subtracted from Hhl_std so that H′hl is found.

As described above, the correcting calculation section 3b serves to carry out a calculation for executing a correcting calculation using θ to increase a control amount so as not to decrease the forward visible distance with a reduction in the ground clearance of the headlamp 5 (that is, for upward turning the optical axis of the irradiation to reduce the ground angle), there by maintaining the visible distance to be constant. In addition, it is possible to obtain θ from an amount which can easily be calculated, for example, a variation in a vehicle height or a pitch angle, without requiring a complicated calculation. Therefore, a processing can be simplified.

While the control in the deceleration has been described above, it is preferable that the control should be carried out to execute a calculation for decreasing a control amount by performing a correcting calculation using θ so as to prevent the direction of the optical axis of the irradiation from being turned excessively upward to increase a great visible distance due to a rise in the ground clearance of the headlamp 5 with the noseup of a vehicle in an acceleration (that is, for downward turning the optical axis of the irradiation to set the ground angle to be greater than the ground reference angle), thereby maintaining the visible distance to be constant. Consequently, it is possible to grasp a change in the ground clearance of the headlamp 5 to fix a distance at which an irradiated light arrives.

While the correcting calculation can be carried out by using only the detected information about the posture of a vehicle in the above example, it is possible to directly obtain a control amount corresponding to the correcting angle e from the acceleration information of the vehicle in a configuration in which the acceleration information can be obtained from the running state detecting means 6.

In the case in which the acceleration is detected in the deceleration of the vehicle by the running state detecting means 6, for example, it is preferable that a correcting amount which is proportional to the absolute value of the acceleration should be calculated and added to a control amount determined by the pitch angle φp (a control amount for correcting the optical axis of the irradiation). By the correction, the optical axis of the irradiation is corrected upward corresponding to an increase in the control amount. Therefore, the ground angle is reduced (a change from α to β) and the forward visible distance is increased (from L′ to L).

Specific examples of the control include the following configurations, for example.

(I) A configuration in which an acceleration is calculated by a differential calculation from a vehicle speed signal or a wheel speed signal and is thus controlled,

(II) A configuration in which an acceleration is detected based on a detection signal sent from an acceleration sensor and is thus controlled, and

(III) A configuration in which a speed and an acceleration are obtained by a time differential from position information about a vehicle and control is carried out by using the acceleration.

In each configuration, an amount which is proportional to the magnitude (absolute value) of the acceleration is obtained (a proportional coefficient is determined by a ratio of the driving amount of the control of the optical axis to the control amount) and is added to a control amount corresponding to the pitch angle, thereby carrying out control to raise the optical axis of the irradiation (the ground angle is set to be smaller than the reference angle).

Although it is assumed that continuous control is carried out in relation to the correction of the optical axis in the configurations described above, it is not restricted but stepwise control can also be performed. More specifically, it is also possible to employ a method in which a plurality of predetermined values is prepared and listed in a table of a memory, and is thus stored as the correction value of a control amount corresponding to the correcting angle θ or the magnitude of an acceleration, and the correction value is selected depending on a change in a pitch angle or a degree of a nosedive in a deceleration and is added to a control amount which is equivalent to a pitch angle. For a simpler method, it is possible to produce an advantage by simply adding a constant correction value to the control amount which is equivalent to the pitch angle when a vehicle is decelerated (If the correction value is too great, the optical axis is excessively corrected. As a result, there is a problem in that a glare is generated. For example, therefore, it is preferable to take such a countermeasure as to previously check a mean correction value related to a nosedive in the deceleration or to provide limiter means so as to prevent the optical axis of the irradiation from being excessively raised beyond a tolerance.).

In the acceleration of the vehicle, it is a matter of course that an acceleration is detected and a correction amount which is proportional to an absolute value thereof is subtracted from a control amount determined by the pitch angle (The reason is that the ground angle of the optical axis of the irradiation is to be more increased if the absolute value of the acceleration is greater.).

In the application of the invention, moreover, it is not necessary to additionally provide vehicle height detecting means (a vehicle height sensor) in the axle portions of front and rear wheels respectively in order to separately detect a change in a vehicle height in the front and rear parts of a vehicle. For example, the invention can be applied to a method (a so-called one sensor method) of additionally providing one vehicle height detecting means in the axle portion of the rear wheel of the vehicle to detect a change in the height and estimating the height of the axle portion of a front wheel by using a predetermined control line.

As is apparent from the above description, according to the first aspect of the invention, it is possible to maintain a forward visible distance which is necessary for the running of a vehicle in the deceleration of the vehicle. Therefore, it is possible to enhance the safety of the running at night.

According to the second aspect of the invention, it is possible to easily carry out a correcting calculation related to the optical axis of irradiation in consideration of a change in the ground clearance of a headlamp for a vehicle depending on the pitch angle of the vehicle.

According to the third aspect of the invention, it is possible to detect an acceleration in the deceleration of the vehicle and to add a correction amount corresponding to a magnitude thereof to a control amount, thereby increasing a forward visible distance in a sudden deceleration.

According to the fourth and fifth aspects of the invention, it is possible to prevent a glare from being generated over a car running in an opposite direction in the acceleration of the vehicle.

What is claimed is:

1. An irradiating direction control apparatus of a headlamp for a vehicle which controls an irradiating direction of the headlamp for the vehicle depending on a change in an posture of the vehicle, comprising:
vehicle posture detecting means for detecting the change in the posture of the vehicle;
irradiation control means for calculating a pitch angle indicative of a vertical inclined posture in a forward direction of the vehicle based on information detected by the vehicle posture detecting means and computing a control amount for correcting an optical axis of irradiation related to the headlamp for the vehicle, and setting a ground angle of the optical axis of the irradiation in a deceleration of the vehicle to be smaller than a ground reference angle of the optical axis of the irradiation during stop or constant speed running of the vehicle, thereby carrying out a correcting calculation for maintaining a forward visible distance of the vehicle to be constant; and
driving means for changing a direction of the optical axis of the irradiation of the headlamp for the vehicle upon receipt of a control command sent from the irradiation control means.

2. The irradiating direction control apparatus of a headlamp for a vehicle according to claim 1, wherein when a ground reference angle of the optical axis of the irradiation is represented as “α”, a ground clearance of the headlamp for the vehicle is represented as “Hhl” and a forward visible distance of the vehicle is represented as “L”,
the irradiation control means subtracts an angle obtained as an inverse tangent of a ratio “Hhl/L” from the ground reference angle “α” and sets the value thus obtained as a correction value to compute a control amount for correcting the optical axis of the irradiation based on an amount obtained by correcting the value of the pitch angle.

3. The irradiating direction control apparatus of a headlamp for a vehicle according to claim 1, further comprising running state detecting means for detecting a running state of the vehicle,
wherein when an acceleration in a deceleration of the vehicle is detected by the running state detecting means, the irradiation control means adds a correction amount which is proportional to an absolute value of the acceleration to a control amount determined by the pitch angle.

4. An irradiating direction control apparatus of a headlamp for a vehicle which controls an irradiating direction of the headlamp for the vehicle depending on a change in an posture of the vehicle, comprising:
vehicle posture detecting means for detecting the change in the posture of the vehicle;
irradiation control means for calculating a pitch angle indicative of a vertical inclined posture in a direction of advance of the vehicle based on information detected by the vehicle posture detecting means and computing a control amount for correcting an optical axis of irradiation related to the headlamp for the vehicle, and setting a ground angle of the optical axis of the irradiation in an acceleration of the vehicle to be greater than a ground reference angle of the optical axis of the irradiation during stop or constant speed running of the vehicle, thereby carrying out a correcting calculation for maintaining a forward visible distance of the vehicle to be constant; and
driving means for changing a direction of the optical axis of the irradiation of the headlamp for the vehicle upon receipt of a control command sent from the irradiation control means.

5. The irradiating direction control apparatus of a headlamp for a vehicle according to claim 4, further comprising running state detecting means for detecting a running state of the vehicle,
wherein when an acceleration in an acceleration of the vehicle is detected by the running state detecting means, the irradiation control means subtracts a correction amount which is proportional to an absolute value of the acceleration from a control amount determined by the pitch angle.
